(19) United States
(12) Patent Application Publication
(10) Pub. No.: US 2024/0372815 A1
(43) Pub. Date: Nov. 7, 2024

(54) SERVICE APPLICATION DETECTION WITH SMART CACHING

(71) Applicant: VEEGO SOFTWARE LTD., Ramat Gan (IL)

(72) Inventors: Denis SIROV, Tel Aviv (IL); Reffael CASPI, Tel Aviv (IL)

(21) Appl. No.: 18/648,699

(22) Filed: Apr. 29, 2024

Related U.S. Application Data
(60) Provisional application No. 63/463,134, filed on May 1, 2023.

(51) Int. Cl. H04L 47/2441; H04L 43/55

(52) U.S. Cl. CPC H04L 47/2441; H04L 43/55

(57) ABSTRACT

A method comprising: capturing by software agents monitoring a plurality of network interfaces, telemetry data representing a plurality of data flow samples associated with an unknown Internet host connection which is assigned a unique identifier; processing the telemetry data to calculate a respective feature set for the unknown Internet host connection; applying, by each of the software agents, a respective instance of a trained machine learning classifier to the respective feature set calculated by the software agent, to obtain a respective field classification which associates the unknown Internet host connection with a particular application or Internet service category; and determining a final classification with respect to the at unknown Internet host connection, which associates the unknown Internet host connections with a particular application or Internet service category, based on a majority or plurality consensus among all of the field classifications.

### CROSS-REFERENCE TO RELATED APPLICATIONS

This application claims priority from U.S. Application Ser. No. 63/463,134, filed May 1, 2023, entitled “SERVICE APPLICATION DETECTION WITH SMART CACHING,” the contents of which are hereby incorporated herein in their entirety by reference.

### FIELD OF THE INVENTION

The invention relates to the field of computer networks and communications.

### BACKGROUND

Network data traffic monitoring, and in particular, the identification of the particular services and/or applications being use by a client-device within a network, is of great importance for Internet service providers (ISPs) and network operators and administrators. Accurate information about the traffic mix carried by an IP network can allow network operators to identify the requirements that different users impose on the underlying infrastructure, to enable efficient design and provision resources appropriately. In addition, this information can help ISPs to track the growth of different user populations and design the networks to accommodate the diverse needs, as well as shed light on emerging applications and possible misuse of network resources.

Different services and applications have different traffic patterns and associated Quality of Service (QoS) requirements, such as bandwidth, loss, delay, jitter (variation in delay), and best-effort options. For instance, some applications require high bandwidth and low jitter for the network traffic to reach its destination, while other applications may by highly sensitive to delay. Thus, accurate traffic classification has become one of the prerequisites for advanced network management tasks, such as monitoring, QoS management, dynamic pricing, and security.

Accordingly, to properly address the challenges of these varying QoS requirements and manage network resources efficiently, it is vital for service providers and Internet Service Providers (ISPs) to be able to recognize different types of applications utilizing network resources.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: capture, by each of a plurality of software agents monitoring a respective plurality of network interfaces, telemetry data representing a plurality of data flow samples associated with an unknown Internet host connection, wherein the unknown Internet host connection is assigned a unique identifier, process, by each of the plurality of software agents, the telemetry data to calculate a respective feature set for the unknown Internet host connection, apply, by each of the software agents, a respective instance of a trained machine learning classifier to the respective feature set calculated by the software agent, to obtain a respective field classification which associates the unknown Internet host connection with a particular application or Internet service category, and determine a final classification with respect to the at unknown Internet host connection, which associates the unique identifier with a particular application or Internet service category, based on a majority or plurality consensus among all of the field classifications.

There is also provided, in an embodiment, a computer-implemented method comprising: capturing, by each of a plurality of software agents monitoring a respective plurality of network interfaces, telemetry data representing a plurality of data flow samples associated with an unknown Internet host connection, wherein the unknown Internet host connection is assigned a unique identifier; processing, by each of the plurality of software agents, the telemetry data to calculate a respective feature set for the unknown Internet host connection; applying, by each of the software agents, a respective instance of a trained machine learning classifier to the respective feature set calculated by the software agent, to obtain a respective field classification which associates the unknown Internet host connection with a particular application or Internet service category; and determining a final classification with respect to the at unknown Internet host connection, which associates the unique identifier with a particular application or Internet service category, based on a majority or plurality consensus among all of the field classifications.

There is further provided, in an embodiment, a computer program product comprising a non-transitory computer-readable storage medium having program instructions embodied therewith, the program instructions executable by at least one hardware processor to: capture, by each of a plurality of software agents monitoring a respective plurality of network interfaces, telemetry data representing a plurality of data flow samples associated with an unknown Internet host connection, wherein the unknown Internet host connection is assigned a unique identifier; process, by each of the plurality of software agents, the telemetry data to calculate a respective feature set for the unknown Internet host connection; apply, by each of the software agents, a respective instance of a trained machine learning classifier to the respective feature set calculated by the software agent, to obtain a respective field classification which associates the unknown Internet host connection with a particular application or Internet service category; and determine a final classification with respect to the at unknown Internet host connection, which associates the unique identifier with a particular application or Internet service category, based on a majority or plurality consensus among all of the field classifications.

In some embodiments, the unique identifier is based, at least in part, on one or more connection-related attributes selected from the group consisting of: Internet Protocol (IP) address, server IP, Uniform Resource Locater (URL), Uniform Resource Identifier (URI), Unique IDentifier (UID), Media Access Control (MAC) address, service name, domain name, port numbers and ranges, and protocol used.

In some embodiments, the unique identifier is based, at least in part, on a combination of data flow-based features extracted from data traffic flows associated with the Internet host connection.

In some embodiments, the feature set calculated by each of the software agents comprises features representing at least one of the following feature categories: (i) the ratio of time-windows within each of the data flow samples having data spikes representing data rates or packet rates which exceed a specified threshold; (ii) statistics associated with the width, amplitude, and frequency of occurrence of the data spikes; (iii) statistics associated with inbound and outbound data and packet rates over the time-windows; (iv) statistics associated with packet sizes in the time-windows; (v) the ratio of the time-windows having a number of inbound packets that is greater than a specified threshold; and (vi) a measure of time periods within each of the time-windows in which inbound or outbound data rates are below a specified threshold.

In some embodiments, at least some of the data flow samples represent an entire usage session by a client-device with respect to the application or Internet service provided by the Internet host connection.

In some embodiments, with respect to each of the software agents, the plurality of data flow samples comprises at least 10 data flow samples.

In some embodiments, all of the field classifications are uploaded to a central server, wherein the determining is performed by the central server, and wherein the final classifications are stored at the central server.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIGS. 1A-1B illustrate exemplary network environments for the execution of at least some of the program instructions involved in performing the inventive methods, in accordance with various aspects of the present disclosure;

FIG. 2 shows a block diagram of an exemplary system for the execution of at least some of the program instructions involved in performing the inventive methods of the present technique, in accordance with various aspects of the present disclosure;

FIG. 3A illustrates the functional steps in a method for central super-learner application-level classification of network traffic over a plurality of communications networks, in accordance with various aspects of the present disclosure, in accordance with various aspects of the present disclosure;

FIG. 3B illustrates the functional steps in a method for consensus-based application-level classification of network traffic over a plurality of communications networks, in accordance with various aspects of the present disclosure, in accordance with various aspects of the present disclosure;

FIG. 4A provides an overview of a pipeline for training a machine learning model of the present disclosure, in accordance with various aspects of the present disclosure; and

FIG. 4B illustrates an inferencing pipeline of a machine learning classifier of the present disclosure, in accordance with various aspects of the present disclosure.

### DETAILED DESCRIPTION

Disclosed herein is a technique, embodied as a system, a computer-implemented method, and a computer program product, which provides for machine learning-based automated, real-time, application-level classification of network data traffic. In some embodiments, the present disclosure provides for classification of data traffic transmitted over a data communications network, as originating from a particular application or Internet service selected from a set of applications or service categories, such as audio and video media streaming, file downloading, file uploading, online gaming, conferencing, social network usage, Internet browsing, VPN session, electronic mail usage, and remote desktop session. In some embodiments, application-level classification of network data traffic may enable further determining of service priority and/or Quality of Service (QoS) requirements.

As noted above, network traffic characterization and application-level classification are crucial components for advanced network management tasks by Internet Service Providers (ISPs) and service providers, to allow for efficient allocation of resources, as well as QoS and network security management.

In a non-limiting example, in the context of residential Wi-Fi networks, QoS variability experienced by client-devices drives many complaints to ISPs. However, the performance of the home or residential network is largely beyond the access and control of the ISPs. Poor performance from Wi-Fi connected devices may be caused by a variety of factors, such as devices being too far from a wireless router or AP, the router or AP being turned off or not working properly, the router or AP itself receiving poor service from the external network, interference from other equipment within the home, or authentication issues between networked devices and the router or AP. Thus, in many cases, an important first step in determining a cause for poor service is identifying the type or category of service, as well as the actual application being used by an end-device, because each service type and application requires a different set of service attributes to enable a reliable and stable connection.

However, several factors combine to make network traffic characterization and application-level detection and classification a challenging task. These factors include, but are not limited to:
Regulatory and user-imposed privacy requirements, which may limit the ability of enterprises to monitor network traffic in a way that may reveal user-level personal information.
A growing trend of data encryption of network traffic, which randomizes the original data in a way which limits the ability to detect discriminative patterns to aid in classification.
The use of common libraries among applications, especially in mobile applications, as well as the use of content delivery networks, tunnelling through Virtual Private Networks (VPNs), or hosting by cloud providers, which cause applications to share many network traffic characteristics, and may mask and obfuscate the source and origin of the data.
The dynamic nature of application network traffic, which often depends on user interaction with the application.

Known techniques for network traffic characterization and application-level identification include a combination of one or more of a port-based approach, payload inspection techniques, and statistical approaches. Traffic classification via port number uses the information in the TCP/UDP headers of the packets to extract the port number. After the extraction of the port number, it is compared with the IANA TCP/UDP port number is assumed to be associated with a particular application. However, the pervasiveness of port obfuscation, network address translation (NAT), port forwarding, protocol embedding and random ports assignments have significantly reduced the accuracy of this approach. Payload inspection techniques based on the analysis of information available in the application layer payload of packets. However, this approach suffers from the need for updating patterns whenever a new protocol is released, as well as user privacy issues. Statistical approaches are based on the assumption that the underlying traffic for each application has unique statistical patterns.

Accordingly, in some embodiments, the present technique provides for learning associations between uniquely-identified Internet host connections (based on unique connection-related signatures) and a particular application or Internet service type (such as, but not limited to, media streaming including audio and video streaming; file downloading; file uploading; online gaming; and/or live conferencing). Thus, the present technique is able to learn that a uniquely-identified Internet host connection is associated with a particular application or Internet service type.

In some embodiments, the Internet host connection may be uniquely-identified by one, or a combination of two or more, connection attributes, including, but not limited to, Internet Protocol address (IP address), port number or a range of port numbers, domain name, and the like. Additionally or alternatively, the Internet host connection may be uniquely-identified by a specific combination of data flow-based, data packet-based, or temporal-based (i.e., time-related) features extracted from data traffic flows between the host and one or more client-devices.

In some embodiments, the present technique provides for a repository housed within, e.g., a central server, and configured for storing the learned associations, wherein each uniquely-identified Internet host connection may be associated with a particular application or a type of Internet service. In some embodiments, such central repository may be stored on a dedicated server, e.g., a cloud server, and may be accessed by ISPs and/or other service providers to identify an actual application or service type being used by client-devices within serviced networks, and to use this information to improve overall service efficiency, allocate network resources more efficiently, and resolve network malfunctions.

In some embodiments, the present technique provides for learning associations between uniquely-identified Internet host connections (based on unique connection-related signatures) and a particular application or Internet service type, based on a trained machine learning model.

In some embodiments, the present disclosure provides for training a machine learning model using a training dataset comprising one or more sets of features calculated from telemetry data associated with data traffic flows over a plurality of network interfaces. In some embodiments, a training dataset of the present disclosure may be constructed from telemetry data associated with a plurality of data traffic flows captured over one or more communications networks, wherein the data traffic flows may be associated with multiple categories and/or applications or Internet service categories. Thus, in some embodiments, such a dataset may comprise features calculated from telemetry data extracted from multiple data traffic flows associated with two or more categories and/or classes of interest, e.g., features calculated from data traffic session instances associated with 2, 3, 4, 5, 10, 15, or more categories and/or classes of interest, each of which may represent a different application or Internet service.

In some embodiments, the captured telemetry data may be used to generate one or more sets of features for a training dataset of the present disclosure, comprising telemetry data representing a plurality of data traffic flows associated with multiple categories and/or classes, each of which may represent a particular application or Internet service category. In some embodiments, a training dataset of the present disclosure may also be enhanced with features calculated from data traffic flows associated with additional and/or other unrecognized applications or Internet services, and/or other data traffic categories.

In some embodiments, the present disclosure provides for analyzing and processing the telemetry data, to extract one or more categories of telemetry data features. In some embodiments, analyzing and processing the telemetry data includes segmenting each data traffic session into a sequence of time-windows, which may be partially overlapping, and extracting the specified features separately from each time-window. In some embodiments, the extracted features may include, but are not limited to, data flow-based, packet-based, and/or temporal-based (i.e., time-related) features. In some embodiments, each of these features may be associated with one of the following feature categories:
Data spikiness: The rate of data and/or packets arriving within each specified time-window within a data traffic session.
Data in/out ratio: A ratio of inbound-to-outbound data and/or packets within a specified time-window in a data traffic session.
Inter-arrival time: Inter-arrival timing of data and/or packets within a specified time-window in a data traffic session.
Connection context: Data traffic session connection context, e.g., the number and handling of open connections or sub-connections associated with the requested service.

In some embodiments, one or more data preprocessing operations may be applied to the raw data and/or to the calculated and extracted features. The preprocessing operations comprise at least one of data noise reduction, data cleaning/filtering, data normalizing, data quality control, and/or any other suitable preprocessing method or technique. In some embodiments, some data preprocessing operations may occur before and/or after the feature extraction stage. In some embodiments, a data preprocessing stage may comprise a data cleaning operation configured to remove irrelevant or redundant data packets from the telemetry data, which may take place before the feature extraction stage. In some embodiments, data normalization may comprise normalization of the extracted features. In some embodiments, the preprocessing stage may also further include feature selection, dimensionality reduction, and/or any other suitable preprocessing method or technique.

In some embodiments, a training dataset of the present disclosure comprises a set of labeled examples on which a machine learning model of the present disclosure may be trained to build a set of classification rules, to classify unseen examples. Accordingly, in some embodiments, the features extracted from the plurality of data traffic may be labeled with a label indicating a “ground truth” class or category associated with the particular data traffic, e.g., a specific application or Internet service category that is the source of the data traffic. In some embodiments, a training dataset of the present disclosure may be labeled using manual, semi-automated, or automated methods. For example, in some embodiments, a training dataset may comprise a portion of labeled feature sets, combined with unlabeled features.

In some embodiments, a machine learning model may be trained on the training dataset constructed as detailed above, to obtain a trained machine learning model able to classify target unseen telemetry data as originating from one of several predetermined applications or Internet services categories. Thus, in some embodiments, a trained machine learning model of the present technique receives telemetry data with respect to data traffic flow between a client-device and an unknown host connection, and classifies the target telemetry data as associated with a particular application or a type of Internet service. The classification result may then be used to associate the unknown host connection with the particular application or type of Internet service. The association may then be stored in a central repository, which may then be accessed by ISPs and/or other service providers, as described above.

In some embodiments, a machine learning model may be trained on the training dataset constructed as detailed above, to obtain a trained machine learning model able to classify target unseen telemetry data as originating from one of several predetermined applications or Internet services categories. Thus, in some embodiments, a trained machine learning model of the present technique receives telemetry data with respect to data traffic flow between a client-device and an unknown host connection, and classifies the target telemetry data as associated with a particular application or a type of Internet service. The classification result may then be used to associate the unknown host connection with the particular application or type of Internet service.

In one example, an instance of a trained machine learning model of the present technique may be deployed at a node of a data communications network (e.g., an access point or router of residential or office wireless network). The trained machine learning model may be configured to continuously or periodically monitor data traffic flows over the network, to capture data traffic flows between client-devices serviced by the network and one or more unknown host connections. The trained machine learning model may then process the captured data traffic flows to obtain telemetry data, and classify the telemetry data as associated with a particular application or type of Internet service. In such cases, the deployed instance of the trained machine learning model may be operated by, e.g., an ISP, to identify, in real-time or near real-time, an application/service being used by an end user within the network, to assist in resolving a specific malfunction concerning the end-user.

In another example, a plurality of instances of the machine learning model of the present technique may be deployed at a corresponding plurality of nodes of data communications networks (e.g., a plurality of access points or routers of residential or office wireless networks). For example, an ISP may install software agents, each comprising an instance of the trained machine learning model, in access points of wireless networks serviced by the ISP, to gather information regarding application/service usage patterns by end-users within these networks, and/or to make a determination in real-time, to assist in resolving a specific malfunction concerning a particular end-user.

The plurality of individual instances of the trained machine learning model may each be configured to continuously or periodically monitor data traffic flows over their respective networks, to capture data traffic flows between client-devices serviced by the network, and one or more unknown host connections providing Internet services (such as, but not limited to, media streaming including audio and video streaming; file downloading; file uploading; online gaming; and/or live conferencing). Each instance of the trained machine learning model may then process the captured data traffic flows to obtain telemetry data, and classify the telemetry data as associated with a particular application or type of Internet service. For example, the plurality of deployed instances of the machine learning model may be operated continuously or periodically to provide continuous information regarding the applications and/or service categories being used by end-users of wireless networks serviced by a particular ISP. In other cases, as noted above, a particular instance of the machine learning model may be operated to perform a classification in real-time or near-real time, regarding an application/service being used by a particular end-user.

In some cases, the associations learned by the multiple instances of deployed machine learning models may be uploaded and stored at a central repository, which, overtime, will comprise information with respect to a growing number of Internet host connections. As noted above, this information may then be accessed by ISPs and/or other service providers to identify an actual application or service category being used by client-devices within serviced networks, thus potentially saving the need to perform real-time field classification.

However, it should be noted that deploying multiple instances of the trained machine learning models in the field, to be inferenced over samples of captured data flows for classification purposes, may yield overall inconsistent results. For example, data traffic flows often reflect a significant degree of noise and variability, even when using the same application or within the same service category. Thus, various data flows from a particular streaming application (such as YouTube), captured over different network connections at different times, may reflect significantly different patterns and features. The differences may be due to the type of streamed content (audio only or audio plus video), whether the streaming is performed using a dedicated application or an Internet browser, the time of day, etc. Similarly, in the case of live conferencing, the data flows will exhibit differing patterns depending on the ratio of active to quiet periods, for example. This issue is further exacerbated by the fact that ad-hoc field classifications based on data flow samples of limited duration (e.g., 2 minutes) may not reflect the full range of patterns and attributes associated with the corresponding application or service category, and thus not allow for a consistent and reliable classification.

The result is that, often, ad-hoc field classifications using an instance of the trained machine learning model of the present technique, may yield inconsistent classification results. Thus, two or more instances of a trained machine learning models deployed in the field may ultimately yield differing classifications of the same Internet host connection. For example, a first instance of the trained machine learning model, deployed over a first network, may classify data flows from a particular Internet host connection as associated with the service category of streaming. At the same time, a second instance of the trained machine learning model, deployed over a second network, may classify data flows from the same Internet host connection as associated with file downloading. Clearly, such conflicting results would not be useful within the context of a central repository.

To address this challenge, the present technique provides for a consensus-based approach for learning associations between uniquely-identified Internet host connections (based on unique connection-related signatures) and particular applications or categories of Internet service. Thus, in some embodiments, the present technique provides for hosting a plurality of instances of a trained machine learning model of the present technique, at a corresponding plurality of nodes of data communications networks (e.g., access points or routers of home or office networks). Each of the instances of trained machine learning models may be configured to continuously or periodically monitor data traffic flows over the corresponding network to capture data traffic flows between client-devices serviced by the network and one or more unknown host connections. The trained machine learning model may then process the captured data traffic flows to obtain telemetry data, and classify the telemetry data as associated with a particular application or type of Internet service. These ‘field’ classifications learned by the multiple instances of deployed machine learning models may be uploaded and stored at a central repository.

In some embodiments, the central repository will then store, with respect to a particular Internet host connection, an association to an application/service category, based on a majority or plurality consensus among all of the ‘field’ classifications received from the various instances of the trained machine learning model. For example, the central repository may receive 25 ‘field’ classification results with respect to a particular Internet host connection (uniquely-identified, e.g., by an IP address or a combination of two or more host connection attributes). Out of the 25 results, 21 may classify the Internet host connection as associated with a particular streaming application (e.g. YouTube), or more generally, with the service category of ‘streaming.’ However, the remaining 4 results may classify the Internet host connection as associated with the service category of ‘file downloading.’ Accordingly, the central repository may determine that the Internet host connection is associated with the particular streaming application (e.g. YouTube), or with the service category of ‘streaming,’ as the case may be, based on the plurality or majority consensus among the received ‘field’ classification results. In some embodiments, the central repository may assign equal weights to all the received ‘field’ classifications, while in other cases, different weights may be assigned, e.g., based on the number of data flow samples used in reaching each particular classification results.

In some embodiments, the central repository may then use the consensus classifications for periodic re-training and refining of the trained machine learning model, to generate an updated version which may then be re-deployed to the participating network nodes.

In some embodiments, additionally or optionally, a central server of the present technique may be configured to gather a large number of raw data flow samples, from multiple software agents deployed in the field (e.g., various home of office wireless networks). The central server may then apply a trained machine learning model (e.g., an ensemble model or a super-learner model) to features extracted from the gathered samples, to obtain a ‘central’ classification result representing a relatively large variety of data flow samples, representing various usage patterns and events, end users, and network environments.

Accordingly, in some embodiments, a central server of the present technique may be configured to operate a plurality of software agents deployed at a corresponding plurality of nodes of data communications networks (e.g., access points or routers of residential or office wireless networks). For example, an ISP may install software agents in access points of wireless networks serviced by the ISP, to gather information regarding application/service usage patterns by end-users within these networks, and/or to make a determination in real-time, to assist in resolving a specific malfunction concerning a particular end-user.

The individual software agents may each be configured to continuously or periodically monitor data traffic over their respective networks, to capture data traffic flows between client-devices serviced by the network and multiple host connections providing Internet services such as, but not limited to, media streaming including audio and video streaming, file downloading, file uploading, online gaming, and/or live conferencing. Each instance of the software agent may then upload the captured data traffic flows to the central server, wherein the uploaded data may be tagged with the particular application/service category associated therewith. Over time, the data samples uploaded to the central server are likely to include multiple samples associated with each of a large number of Internet host connections of interest (e.g., those associated with common streaming or conferencing applications, such as Netflix, Zoom, etc.). Moreover, the data samples associated with each particular Internet host connection is likely also to represent a large variety of usage patterns and events, end users, network environments, etc.

In some embodiments, the central server may be configured to receive the captured data traffic flows from the plurality of software agents, and to process the captured data traffic samples, to obtain telemetry data. In some embodiments, the central server may then be configured to analyze and process the telemetry data, to extract one or more categories of telemetry data features. In some embodiments, one or more data preprocessing operations may be applied to the raw data and/or to the calculated and extracted features. The preprocessing operations comprise at least one of data noise reduction, data cleaning/filtering, data normalizing, data quality control, and/or any other suitable preprocessing method or technique. In some embodiments, some data preprocessing operations may occur before and/or after the feature extraction stage.

In some embodiments, once a predetermined number of samples (e.g., between 10-50) is received from the deployed software agents with respect to a particular Internet host connection of interest, the central server may apply a machine learning model (which may be an ensemble model or a super-learner model) to the features extracted from the data samples, to obtain a ‘central’ classification result with respect to the Internet host connection of interest. The central server may then use the classification result to associate the Internet host connection with an application/service category, and store the association in the central repository, which may be accessed by ISPs and/or other service providers to identify actual applications or service categories being used by client-devices within serviced networks.

In some embodiments, the central server may use the ‘central’ classification result to validate the ‘field’ classifications received from the various instances of the trained machine learning model deployed in the field. For example, the central repository may receive a number of ‘field’ classification results with respect to a particular Internet host connection. The central server may use the ‘central’ classification to resolve any conflicts or disagreements among the various ‘field’ classifications, e.g., as part of the consensus mechanism described above. In some embodiments, the ‘central’ classification may be assigned a greater weight than the ‘field’ classifications, while in other cases, the ‘central’ classification may be assigned an equal weight.

In a non-limiting example, the present technique may operate within the context of one or more local area networks (LAN) serviced by an ISP and/or another similar service provider. Each of the LANs comprises one or more end or client-devices, e.g., end stations (STAs). A LAN may be connected to the Internet through an access point (AP) and/or a gateway, such as a broadband modem and/or router. In a typical LAN environment, a user may access the Internet by connecting a client-device (which may be a wireless device) to a server on the Internet, via intermediate devices and networks. In some implementations, a client-device may be connected to a LAN configured to communicate with servers on a wide area network (e.g., the Internet) via an access network. In some embodiments, a LAN may be a wireless LAN (WLAN), which includes, e.g., wireless STAs connected through a wireless AP, e.g., a wireless router. In some embodiments, STAs within a LAN can be, but are not limited to, a tablet, a desktop computer, a laptop computer, a handheld computer, a cellular telephone, a smartphone, a network appliance, a camera, a media player, a navigation device, a game console, or a combination of any these data processing devices or other data processing devices.

LANs and WLANs, as described herein, may include wired or wireless client-devices connected through a wired or wireless access point or router. The LANs or WLANs of the present disclosure may include a computer network that covers a limited geographic area (e.g., a home, school, computer laboratory, an office building) using a wired or wireless distribution method. The LAN/WLAN may be connected with the access network via a broadband modem. The wide area network (WAN) may include servers, such as authentication servers, web servers, electronic messaging servers, etc., accessible to the client-device. Home gateways and access points, as described herein, may perform many of the interfacing functions between the home network and an ISP's network. In a large number of cases, the role of the home gateway is combined with that of a wireless AP.

As used herein, the term ‘application-level classification’ may refer to techniques for identifying, determining and/or classifying data traffic provided to, accessed by, requested by, and/or consumed by an STA within a LAN, as originating from one of several predetermined applications or Internet services.

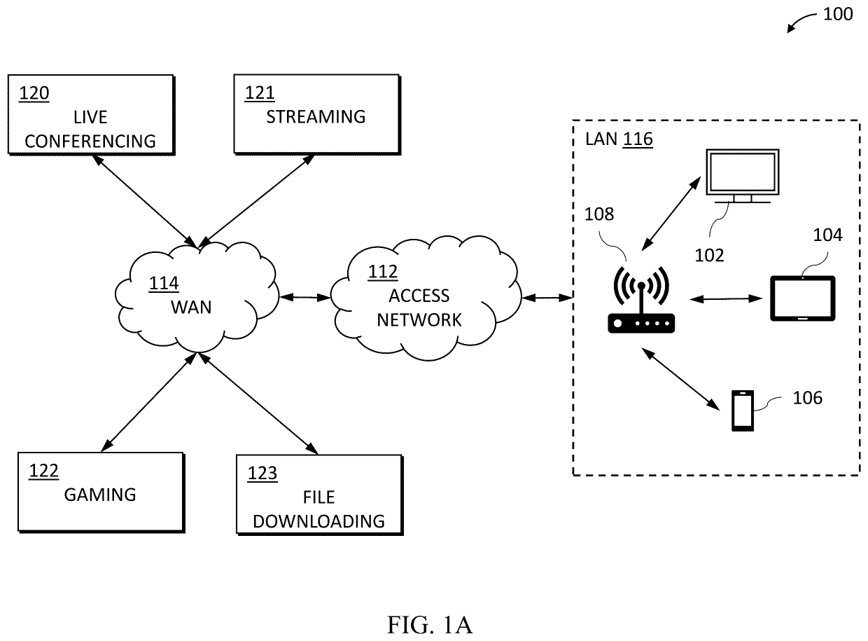

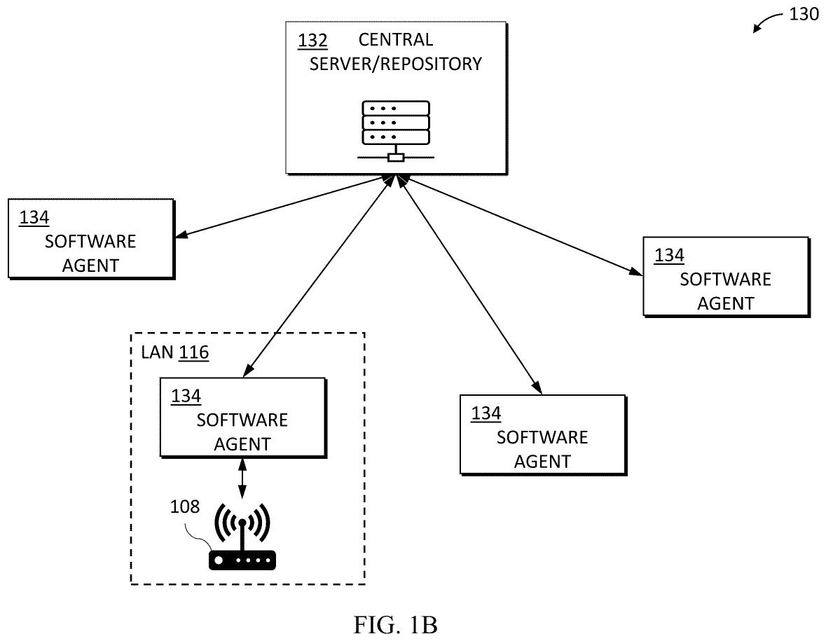

FIG. 1A illustrates an exemplary network environment 100 for the execution of at least some of the program instructions involved in performing the inventive methods of the present technique. Network environment 100 includes STAs 102, 104 and 106 communicably connected to one or more service and/or content providers, such as Internet services platform 120-123, via local area network (LAN) 116, access network 112 and wide area network (WAN) 114. LAN 116 includes AP 108 and STAs 102-106. LAN 116 may be connected with the access network via a broadband modem.

Each of STAs 102-106 can represent various forms of computing devices. In the exemplary network environment 100 shown in FIG. 1, STA 102 is a smart TV, STA 104 is a tablet computer, and STA 106 is a smartphone. However, STAs 102-106 can be any desktop, laptop, or handheld computer; smart watch; network appliance; camera; media player; navigation device; gaming console; printer; scanner; and/or an Internet of Things (IoT) device. Each of Internet services platform 120-123 may be a system or device having a processor, a memory, and communications capability for providing services over an Internet connection, such as, but not limited to, media streaming (including audio and video streaming), file downloading, file uploading, online gaming, live conferencing, social networking, Internet browsing, VPN sessions, electronic mail, and/or remote desktop sessions.

In some example aspects, each of Internet services platform 120-123 can be a single computing device, for example, a computer server. In other embodiments, each of Internet services platform 120-123 can represent more than one computing device working together to perform the actions of a server computer (e.g., cloud computing). Further, each of Internet services platform 120-123 can represent various forms of servers including, but not limited to an application server, a proxy server, a network server, an authentication server, an electronic messaging server, a content server, a server farm, etc., accessible to STAs 102-106.

A user of an STA 102-106 may interact with the content and/or services provided by Internet services platform 120-123 through a client application installed at STAs 102-106. Alternatively, the user may interact with the content and/or services provided by Internet services platform 120-123 through a web browser application install on STAs 102-106. Communication between STAs 102-106 and Internet services platform 120-123 may be facilitated through LAN 116, access network 112 and/or WAN 114.

In some aspects, STAs 102-106 may communicate through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, Wi-Fi, or other such transceiver.

WAN 114 can include, but is not limited to, a large computer network that covers a broad area (e.g., across metropolitan, regional, national or international boundaries), for example, the Internet, a private network, an enterprise network, a cellular network, or a combination thereof connecting any number of mobile clients, fixed clients, and servers.

Further, WAN 114 can include, but is not limited to, any of the following network topologies, including a bus network, a star network, a ring network, a mesh network, a star-bus network, tree or hierarchical network, and the like. WAN 114 may include one or more wired or wireless network devices that facilitate device communications between STAs 102-106 and Internet services platform 120-123, such as switch devices, router devices, relay devices, etc., and/or may include one or more servers.

Access network 112 can include, but is not limited to, a cable access network, public switched telephone network, and/or fiber optics network to connect WAN 114 to LAN 116. Access network 112 may provide last mile access to Internet. Access network 112 may include one or more routers, switches, splitters, combiners, termination systems, central offices for providing broadband services. In some embodiments, access network 112 may include remote server 160 which may perform data traffic monitoring, analysis, and similar operation with respect to LAN 116.

LAN 116 can include, but is not limited to, a computer network that covers a limited geographic area (e.g., a home, school, computer laboratory, a business enterprise, or an office building) using a wired or wireless distribution method. Client-devices (e.g., STAs 102-106) may associate with an AP (e.g., AP 108) to access LAN 116 using Wi-Fi standards.

For exemplary purposes, LAN 116 is illustrated as including multiple STAs 102-106; however, LAN 116 may include only one of STAs 102-106. In some implementations, LAN 116 may be, or may include, one or more of a bus network, a star network, a ring network, a relay network, a mesh network, a star-bus network, a tree or hierarchical network, and the like.

AP 108 can include a network-connectable device, such as a hub, a router, a switch, a bridge, or an AP. The network-connectable device may also be a combination of devices, such as a Wi-Fi router that can include a combination of a router, a switch, and an AP. Other network-connectable devices can also be utilized in implementations of the subject technology. AP 108 can allow client-devices (e.g., STAs 102-106) to connect to WAN 114 via access network 112.

FIG. 1B depicts an exemplary environment 130 for the execution of at least some of the program instructions involved in performing the inventive methods. As can be seen, central server/repository 132 deploys one or more software agents 134 within a variety of data communication networks, such as Lan 116 depicted in FIG. 1A. For example, in the case of LAN 116, software agent 134 may be hosted within AP 108. Each of the software agents may be configured to continuously or periodically monitor data traffic flows over its respective network, to capture data traffic flows between client-devices serviced by the network and one or more unknown host connections. For example, in the case of LAN 116, software agent 134 may be configured to monitor instances of application/service usage by one of STAs 102-106, and to capture data flows between the STAs 102-106 and respective Internet host connections. Each of software agents 134 may calculate telemetry data with respect to data traffic flows within their respective networks, and classify the telemetry data as associated with a particular application or a type of Internet service. The classification result may then be used to associate the target unknown host connection with the particular application or type of Internet service. The association may then be uploaded and stored in central server/repository 132.

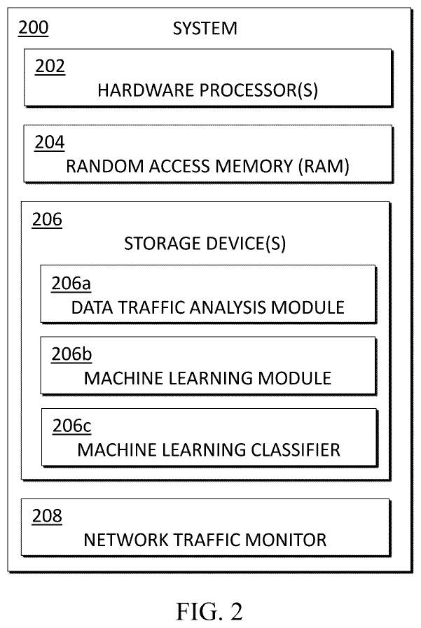

FIG. 2 shows a block diagram of an exemplary system 200 for the execution of at least some of the program instructions involved in performing the inventive methods of the present technique. In some embodiments system 200 may be configured for executing program instructions to train and inference a machine learning model configured to perform application-level classification of network data traffic, in accordance with various aspects of the present disclosure.

System 200 as described herein is only an exemplary embodiment of the present invention, and in practice may have more or fewer components than shown, may combine two or more of the components, or a may have a different configuration or arrangement of the components. The various components of system 200 may be implemented in hardware, software or a combination of both hardware and software. In various embodiments, system 200 may comprise a dedicated hardware device, or may be implement as a hardware and/or software module into an existing device, e.g., an AP, such as AP 108 within LAN 116 shown in FIG. 1A, or may be part of central server/repository 132 shown in FIG. 1B.

System 200 may include one or more hardware processor(s) 202, a random-access memory (RAM) 204, one or more non-transitory computer-readable storage device(s) 206, and a network traffic monitor 208.

Storage device(s) 206 may have stored thereon program instructions and/or components configured to operate hardware processor(s) 202. The program instructions may include one or more software modules, such as data traffic analysis module f, machine learning module 206b, and/or machine learning classifier 206c. The software components may include an operating system having various software components and/or drivers for controlling and managing general system tasks (e.g., memory management, storage device control, power management, etc.), and facilitating communication between various hardware and software components. System 200 may operate by loading instructions of the various software modules 206a-206c into RAM 204 as they are being executed by processor(s) 202.

The network traffic monitor 208 may be configured to continuously or periodically monitor one or more data traffic sessions over one or more data communication networks, such as LAN 116 shown in FIG. 1A.

Network traffic monitor 208 may monitor and capture telemetry data, captured through active and/or passive probing of endpoint devices. In some embodiments, probing by network traffic monitor 208 may entail sending one or more of the following probes:
DHCP probes with helper addresses.
SPAN probes, to get messages in INIT-REBOOT and SELECTING states, use of ARP cache for IP/MAC binding, etc.
Netflow probes.
HTTP probes to obtain information such as the OS of the device, Web browser information, etc.
RADIUS probes.
SNMP to retrieve MIB object or receives traps.
DNS probes to get the Fully Qualified Domain Name (FQDN).
Active or SNMP scanning to retrieve the MAC address of a device or other types of information.

In some embodiments, telemetry data captured by network traffic monitor 208 may also include data packets, connection attributes, user data, or control information associated with various information channels (e.g., control channels, data channels, and information related to managing service discovery over network connections). Information received at network traffic monitor 208 may be processed and transmitted to data traffic analysis module 206a and/or to other components of system 200.

In some embodiments, network traffic monitor 208 may be completely software based, hardware based, or a combination of both. Network traffic monitor 208 may comprise one or more monitoring points, which may be implemented in software and/or hardware devices distributed over a plurality of networks. In some cases, network traffic monitor 208 may be implemented by a vendor, such as an ISP, to monitor network data traffic over a backbone or access network, where the data traffic is associated with a plurality of LANs serviced by the ISP.

In some embodiments, telemetry data captured by network traffic monitor 208 originate in wired networks, but can also originate in wireless networks and virtual environments. In some examples, network traffic monitor 208 may include a circuit or circuitry for monitoring and identifying one or more attributes of a connection. In some embodiments, network traffic monitor 208 may be configured to monitor and determine, e.g., connection throughput (e.g., connection bitrate, packets per second, etc.). In some embodiments, network traffic monitor 208 may comprise a ‘sniffer’ or network analyzer designed to capture telemetry data on a network. In some embodiments, network traffic monitor 208 may be configured to capture telemetry data associated with one or more types or categories of service provided over an Internet connection, e.g., media streaming (including audio and video streaming), file downloading, file uploading, online gaming, live conferencing, social networking, Internet browsing, VPN sessions, electronic mail, and/or remote desktop sessions.

In some embodiments, network traffic monitor 208 may employ any suitable hardware and/or software tool to capture traffic telemetry data. For example, network traffic monitor 208 may be deployed to monitor one or more access networks, access points, end-devices, and/or hosts, to telemetry data associated with data flows sent to or received from the Internet. In some embodiments, network traffic monitor 208 may be configured to determine a corresponding source or application associated with each captured data packet. In some embodiments, network traffic monitor 208 may be configured to timestamp each received packet, and to label each received packet with its associated source or application.

In some embodiments, data traffic analysis module 206a may be configured to receive network data traffic and to preprocess and/or process and analyze the data according to any desirable or suitable analysis technique, procedure or algorithm. In some embodiments, data traffic analysis module 206a may be configured to perform any one or more of the following: data noise reduction, data cleaning, data filtering, data normalizing, and/or feature extraction and calculation.

In some embodiments, the instructions of machine learning module 206b may cause system 200 to receive training data, process it, and output one or more training datasets, each comprising a plurality of annotated data samples, based on one or more annotation schemes. The instructions of machine learning module 206b may further cause system 200 to train and implement one or more machine learning models, e.g., machine learning classifier 206c, using the one or more training datasets constructed by machine learning module 206b.

In some embodiments, machine learning module 206b may implement one or more machine learning models using various model architectures, e.g., convolutional neural network (CNN), recurrent neural network (RNN), or deep neural network (DNN), adversarial neural network (ANN), and/or any other suitable machine learning model architecture. The terms ‘machine learning model’ and ‘machine learning classifier’ are used interchangeably, and may be abbreviated ‘model’ or ‘classifier.’ These terms are intended to refer to any type of machine learning model which is capable of producing an output, e.g., a classification, a prediction, or generation of new data, based on a training scheme which trains a model to perform a specified prediction or classification. Classification algorithms can include linear discriminant analysis, classification and regression trees/decision tree learning/random forest modeling, nearest neighbor, support vector machine, logistic regression, generalized linear models, Naive Bayesian classification, and neural networks, among others.

In some embodiments, the instructions of machine learning classifier 206c may cause system 200 to receive, at an inference stage, input target telemetry data 220 originating from an unknown application or Internet service, and to output an application-level classification 222 of the target input telemetry data 220, which predicts the particular application or Internet service associated with input target telemetry data 220.

In some embodiments, machine learning classifier 206c may be configured to execute any one or more classification algorithms with respect to received data, to generate predictions. The terms ‘classification’ and ‘prediction’ may be used herein interchangeably and are intended to refer to any type of output of a machine learning model. This output may be in the form of a class and a confidence score which indicates the certainty that input data belong to a certain class of a predetermined set of classes. Various types of machine learning models may be configured to handle different types of input and produce respective types of output; all such types are intended to be covered by present embodiments. The terms ‘class,’ ‘category,’ ‘category label,’ ‘label,’ and ‘type’ when referring to service types can be considered synonymous terms with regard to the application-level classification of network data traffic.

System 200 as described herein is only an exemplary embodiment of the present invention, and in practice may be implemented in hardware only, software only, or a combination of both hardware and software. System 200 may have more or fewer components and modules than shown, may combine two or more of the components, or may have a different configuration or arrangement of the components. System 200 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 200 may be co-located or distributed, or the system may be configured to run as one or more cloud computing ‘instances,’ ‘containers,’ ‘virtual machines,’ or other types of encapsulated software applications, as known in the art. As one example, system 200 may in fact be realized by two separate but similar systems. These two systems may cooperate, such as by transmitting data from one system to the other (over a LAN, a WAN, etc.), so as to use the output of one module as input to the other module.

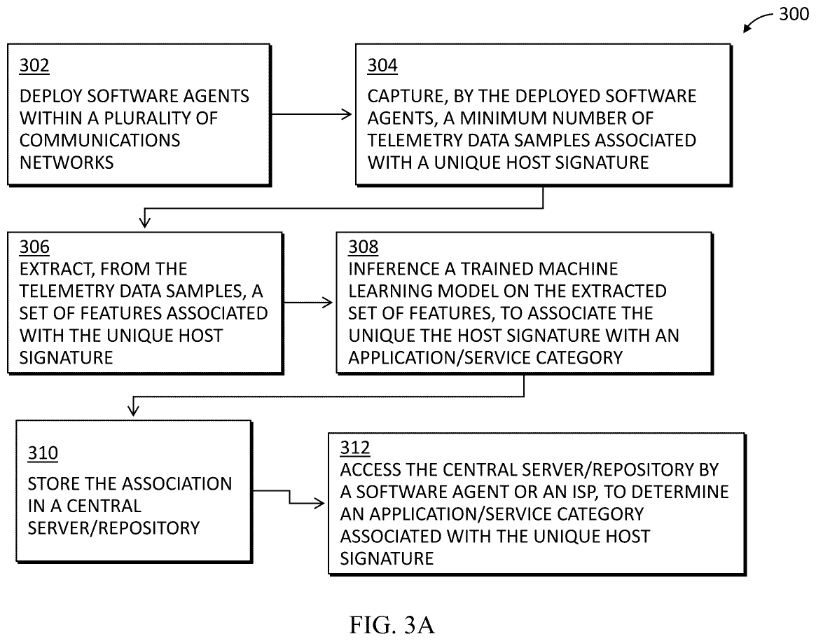

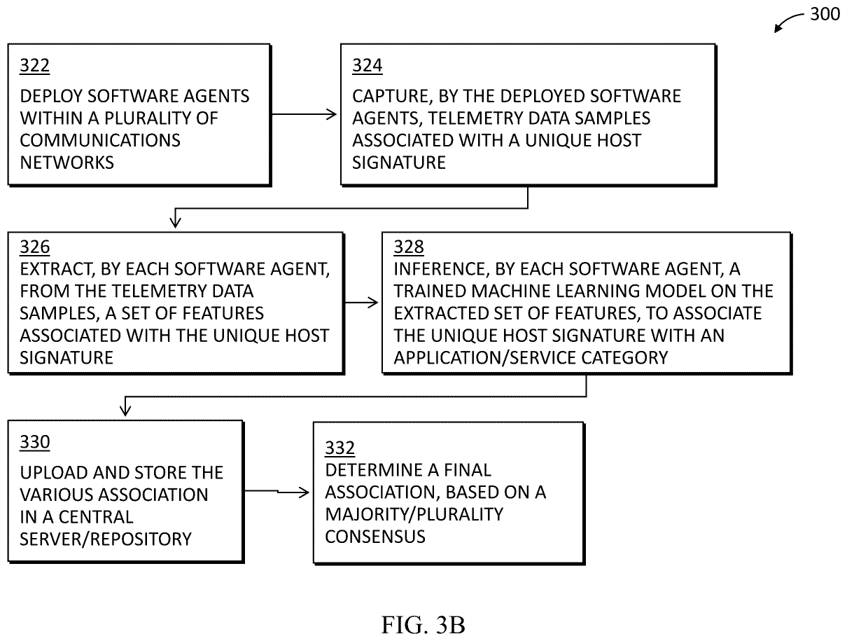

The instructions of system 200 will now be discussed with reference to the flowchart of FIG. 3A, which illustrates the functional steps in a method 300 for central super-learner application-level classification of network traffic over a plurality of communications networks, in accordance with various aspects of the present disclosure.

The various steps of method 300 will be described with continued reference to the exemplary environments of FIGS. 1A-1B, and to system 200 shown in FIG. 2. The various steps of method 300 may either be performed in the order they are presented or in a different order (or even in parallel), as long as the order allows for a necessary input to a certain step to be obtained from an output of an earlier step. In addition, the steps of method 300 may be performed automatically (e.g., by system 200 of FIG. 2), unless specifically stated otherwise.

Method 300 begins in step 302, wherein a plurality of software agents, such as software agents 134 depicted in FIG. 1B, are deployed within a corresponding plurality of communications network, such as LAN 116 depicted in FIG. 1A. In some embodiments, each software agent 134 may be hosted within a network node in its respective network, e.g., an access point or router, such as AP 108 in the case of LAN 116. In some embodiments, each of software agents 134 is operationally and communicatively connected to, and controlled by, a central server, such as central server/repository 132. For example, central server/repository 132 may realize the components of system 200 centrally, to control and operate each of the software agents 134. Alternatively, system 200 may be realized by a distributed system, such that central server/repository 132 and each of software agents 134 may host a local instance of system 200 in its entirety, or at least some of the components of system 200, and operate by transmitting data from one system to the other (over a LAN, a WAN, the Internet, etc.).

In some embodiments, in step 304, the instructions of network traffic monitor 208 may cause system 200 to operate the various deployed software agents 134 to monitor and capture data traffic flows and telemetry data over their respective communications networks. In some embodiments, the data traffic flows are associated with instances of an application or service usage by an STA within the network in conjunction with a uniquely-identified Internet host connection of interest (based on unique connection-related signature), e.g., one of Internet services platform 120-123 in FIG. 1A.

As used herein, “uniquely-identified” refers to the ability to detect and store a unique signature (or two or more unique signatures) for an Internet host connection, wherein the unique signature comprises one or more connection-related attributes. The unique signature(s) can then be used to positively or affirmatively identify the particular Internet host connection as the source of a new instance of data traffic connection. An Internet host connection can thus have more than one signature, however, no two Internet host connections share signatures. It is important to note that the unique signature does not necessarily indicate the type or category of application or service provided by the host, but rather only that this (otherwise unknown) host is positively associated with a data traffic session provided to a client device within a network. The connection-related attributes which may be used to create a unique signature typically include Internet Protocol address (IP address), port number or a range of port numbers, domain name, and the like. The Internet host connection may be uniquely-identified by one, or a combination of two or more, connection attributes, including, but not limited to, Internet Protocol address (IP address), port number or a range of port numbers, domain name, and the like. Additionally or alternatively, the Internet host connection may be uniquely-identified by a specific combination of data flow-based, packet-based, or temporal-based (i.e., time-related) features extracted from data traffic flows associated with the Internet host connection.

In some embodiments, the application/service category is one of the following: media streaming (including audio and video streaming), file downloading, file uploading, online gaming, conferencing, social network usage, Internet browsing, VPN session, electronic mail usage, and remote desktop sessions.

In some embodiments, the instructions of network traffic monitor 208 may cause system 200 to operate the various deployed software agents 134 to collect at least a predetermined number of telemetry data samples (e.g., between 10-100 samples) from each of the software agents 134, with respect to the uniquely-identified Internet host connection of interest.

In some embodiments, each telemetry data sample may represent an entire application/service category usage session by a user within a network, with respect to the uniquely-identified Internet host connection. For example, such a usage session may include all data traffic flows associated with an instance of usage (such as content streaming, a video conferencing call, or a gaming session) wherein a user accessed the uniquely-identified Internet host connection. In some embodiments, each usage session may have minimum length of between 1-30 minutes.

Accordingly, the individual software agents 134 may each be configured to continuously or periodically monitor data traffic over their respective networks, to capture data traffic flows between client-devices serviced by the network and the uniquely-identified host connection. Over time, the data flow samples associated with the uniquely-identified host connection are likely also to represent a large variety of usage patterns and events, end users, network environments, days of the week, times of day, etc.

For example, with reference to FIG. 1A, a user, such as STA 102 within LAN 116, may initiate a data traffic session with an unknown application or Internet host, e.g., Internet host 121, to stream media over an Internet connection. In some embodiments, in order to fetch the service, STA 102 may open one or more sub-connections, e.g., two or more parallel sub-connections to fetch the multiple resources comprising the single instance of requested service. In some embodiments, the respective software agent 134 may continuously or periodically monitor and sample the one or more established sub-connections, e.g., 1, 2, 3, 4, 5 or more sub-connections (which may be referred to as the ‘connection context’), to capture telemetry data associated with the service being provided to STA 102.

In some embodiments, each software agent 134 may thus be operated to capture data packets associated with data traffic flows, and may further aggregate data packets into sequences or flows comprising IP data packets passing a monitoring point in the network during a certain time interval, such that all packets belonging to a particular flow sample have a set of common properties. In some embodiments, such time interval may be, e.g., 1, 5, 10, 15, 20, 25, 30, 60, 120 seconds or greater. Similarly, each software agent 134 may further be operated to analyze packet headers, to capture telemetry data about the traffic flows.

In some embodiments, each software agent 134 may be operated to capture connection attributes associated with each data flow between an STA and a host connection, such as, but not limited to:
Internet Protocol (IP) address.
Server IP
Uniform Resource Locater (URL).
Uniform Resource Identifier (URI).
Unique IDentifier (UID).
Media Access Control (MAC) address.
Service name.
Domain name.
Port numbers and ranges.
and/or
Protocol used.

Further example attributes in the captured telemetry data may include, but are not limited to, Transport Layer Security (TLS) information (e.g., from a TLS handshake), such as the ciphersuite offered, User Agent information, destination hostname, TLS extensions, etc., HTTP information (e.g., URI, etc.), Domain Name System (DNS) information, ApplicationID, virtual LAN (VLAN) ID, or any other data features that can be extracted from the observed traffic flows. Further information, if available, could also include process hash information from the process on the particular one or more STAs 102-106 that participates in the traffic flows. In addition, any number of statistics or metrics may be extracted regarding the traffic flows. For example, the start time, end time, duration, packet size(s), the distribution of bytes within a flow, etc., associated with the traffic flows.

In further embodiments, each software agent 134 may also be operated to assess the payload of the included packets in the traffic flows, to capture information about the traffic flows. For example, each software agent 134 may perform deep packet inspection (DPI) on one or more of the included packets, to assess the contents of the packets. Doing so may, for example, yield additional information that can be used to determine the application associated with the traffic flows (e.g., the packets were sent by a web browser of a particular one of STAs 102-106, by a videoconferencing application, etc.).

In some embodiments, the telemetry data may be captured over specified usage periods. For example, each software agent 134 may be operated to capture network traffic flows and telemetry data over a specified period of time, such as a period extending between 1 hour and 365 days of usage, e.g., 24 hours of usage. In some embodiments, a specified period of usage time may be a continuous period of usage, e.g., a continuous 24 hours representing usage of the device throughout all hours of the day.

In some embodiments, telemetry data may be captured over entire data traffic sessions between an STA and an Internet host, e.g., over entire usage sessions wherein a user may initiate a data traffic session with an application or Internet service, e.g., to stream media, to conduct a teleconference, etc.

In some embodiments, the instructions of network traffic monitor 208 may cause system 200 to operate each of software agents 134 to capture telemetry data associated with the connection context of one or more instances of application or service usage sessions. For example, in some embodiments, in order to fetch a particular service or application usage session, an STA, such as one of STAs 102-106, may open two or more sub-connections, e.g., 1, 2, 3, 4, 5 or more sub-connections, to fetch the multiple resources comprising the requested service. In some embodiments, the software agents 134 may be operated to continuously or periodically monitor and sample the established sub-connections, to capture telemetry data associated therewith.

In some embodiments, each software agent 134 may be operated to generate a record of each flow sample, which may include information about each flow sample that was observed, e.g., an application or service or Internet services associated with the flow sample, characteristic properties of a flow sample (e.g., IP addresses and port numbers) as well as size-based and temporal properties (e.g., packet and byte counters). In some embodiments, each software agent 134 may be operated to timestamp received flow samples upon packet arrival.

In some embodiments, each software agent 134 may be operated to determine an application or content or Internet service information associated with each flow sample, based on connection parameters such as, but not limited to, domain name, IP address, and/or port numbers. In some embodiments, a domain name may be determined using a Secure Socket Layer (SSL) certificate, which provides a fully qualified domain name associated with a server as verified by a trusted third party service. For example, a reverse DNS lookup or reverse DNS resolution (rDNS) may be carried out to determine the domain name associated with an IP address. In other examples, each software agent 134 may be operated to determine port numbers associated the IP address, and/or a transport protocol, e.g., Transmission Control Protocol (TCP) and the User Datagram Protocol (UDP). In the case of port number ranges, because many Internet resources use a known port or port ranges on their local host as a connection point to which other hosts may initiate communication, each software agent 134 may be operated to analyze TCP SYN packets to know the server side of a new client-server TCP connection.

In some embodiments, application and/or Internet service detection based on detecting a URL or a server IP address and associating the URL or IP address with a known domain found, e.g., in repository of domain names associated with a specified application or Internet service. For example, known domain names associated with any particular application or category of service may be identified and added to a database of domain name maintained by central server/repository 132. In some embodiments, such detection may be further supported by, e.g., an expression or a string (e.g., a regex) which may be associated with a particular application or Internet service (e.g., ‘Netflix’), an expected port range associated with the service type, or an expected protocol associated with the Internet service.

In some embodiments, a database of known domain names associated with particular applications or Internet services may be obtained using, e.g., a dedicated crawler configured to systematically browses the Internet for the purpose of identifying and indexing domain names based on a type, content, etc. A crawler typically travels over the Internet and accesses resources. The crawler inspects, e.g., the content or other attributes of resources. The crawler then follows hyperlinks to other resources. The results of the crawling are then extracted into a repository, which may be queried to find content that is relevant to a particular task. Thus, for example, a URL or IP address associated with a service being provided to an STA in LAN 116 may be matched with an entry in a domain repository maintained by system 200. In such case, the service may be determined to be a category of service associated with the matched domain name.

With reference back to FIG. 3A, in some embodiments, the instructions of network traffic monitor 208 may further cause system 200 to operate each of the software agents 134 to sample and/or filter the collected telemetry data, such that only certain packets are retained and forwarded for further processing. In some embodiments, a combination of several sampling and filtering steps can be adopted to select only packets of interest, to reduce computational load of subsequent stages or processes as well as the consumption of bandwidth and memory. For example, systematic sampling may be applied, wherein only every Nth packet is selected in a periodic sampling scheme. In other example, random sampling may be applied to select packets in accordance with a random process. In some embodiments, one or more filtering schemes may be applied, e.g., to select packets where specific fields within the packet (and/or the router state) are equal to a specified value or inside a specified value range. In other examples, packets that are used for handshake generation and do not contain any useful information about the protocol or service being used may be removed (e.g., SYN, ACK, FIN packets).

In some embodiments, in step 306, once a predetermined minimum number of telemetry data samples has been gathered with respect to the uniquely-identified host connection of interest (e.g., a minimum of between 10-100 samples), the instructions of data traffic analysis module 206a may cause system 200 to operate the various deployed software agents 134 to process the captured telemetry data samples, to extract a set of data traffic features therefrom. In some embodiments, one or more data preprocessing operations may be applied by each of the deployed software agents 134 to the raw telemetry data and/or to the calculated and extracted features, such as data noise reduction, data cleaning/filtering, data normalizing, data quality control, and/or any other suitable preprocessing method or technique.

Alternatively, in some embodiments, once a predetermined minimum number of telemetry data samples has been gathered with respect to the uniquely-identified host connection of interest (e.g., a minimum of between 10-100 samples), the instructions of data traffic analysis module 206a may cause system 200 to operate each of the software agents 134, to upload the captured telemetry data samples to central server/repository 132. In some embodiments, each software agent 134 thus may upload telemetry data tagged with a signature or another identifier of the uniquely-identified Internet host connection. In some embodiments, the instructions of data traffic analysis module 206a may then cause system 200 to receive the captured telemetry data from the plurality of software agents 134, and to extract one or more categories of telemetry data features therefrom. In some embodiments, one or more data preprocessing operations may be applied to the raw telemetry data and/or to the calculated and extracted features, such as data noise reduction, data cleaning/filtering, data normalizing, data quality control, and/or any other suitable preprocessing method or technique. Accordingly, in some embodiments, system 200 may extract sets of features from the telemetry data captured and uploaded in step 304, as further detailed hereinbelow.

In some embodiments, step 306 involves calculating a set of features with respect to the uniquely-identified Internet host connection, from the plurality of telemetry data samples gathered with respect thereto. As noted above, the feature calculation may be performed by each software agents 134 from the telemetry data samples captured by each software agent 134, or centrally by system 200, from telemetry data samples uploaded by the various software agents 134.

In some embodiments, the Internet host connection may be uniquely-identified by one, or a combination of two or more, connection attributes (such as IP address, port number or a range of port numbers, domain name, and the like). Additionally or alternatively, the Internet host connection may be uniquely-identified by a unique signature, which may comprise a specific combination of features extracted in step 306 from the data traffic flows between the uniquely-identified host and one or more client-devices. For example, a predetermined function may be applied to the features extracted from telemetry data originating from a uniquely-identified Internet host connection, to generate the unique signature which may be used to recognize the Internet host connection.

In some embodiments, the extracted features may include, but are not limited to, data flow level or temporal (i.e., time-related) features, as well as packet-level or size-based features. In some embodiments, the features may be extracted from each telemetry sample with respect to a moving time-window interval of between 1-240 seconds, e.g., 30 seconds. In some embodiments, each of these features may be associated with one of the following categories of features:
Data spikiness: The ratio of time-windows within a flow sample showing data rates or packet rates which exceed one or more specific thresholds. In some embodiments, the one or more thresholds may reflect static values, e.g., 1 KB, 2 KB, 3 KB, 100 KB, 200 KB, 300 KB, or 10 packets, 30 packets, 50 packets, etc. In some embodiments, the threshold may be a dynamic threshold whose value may reflect, e.g., the average data/packet rate within a particular time-window or a series of two or more time-windows, plus the standard deviation of the data/packet rate.
Data spikes attributes: Statistics and metrics calculated with respect to identified data rate or packet rate spikes. Such statistics and metrics may be calculated with respect to the width, amplitude, and frequency of occurrence of data spikes, and may include, but are not limited to, mean values, average values, minimum values, maximum values, standard deviation, variance, and distribution.
Packet Rate: The number of packets in rate and packets out rate sent over one or more time-windows, including, but not limited to, mean values, average values, minimum values, maximum values, standard deviation, variance, and distribution.
Packet sizes: Mean values, average values, minimum values, maximum values, standard deviation, variance, and distribution of packet sizes transmitted over one or more time-windows.
Ratio of inbound-to-outbound data: The mean ratio between inbound and outbound data and/or packets over all time-windows in a flow sample, as well as minimum, maximum, variance, and/or distribution of such ratio.
Ratio of valid time-windows: The ratio of time-windows having a number of inbound packets that is greater than a specified threshold.
Inter-arrival timing of packets: A measure of time periods within a flow sample in which inbound (e.g., ‘quiet in’) or outbound data (e.g., ‘quiet out’) amounts to less than a specified threshold, e.g., 50B.

In some embodiments, the following additional features may be calculated, including, but not limited to:
Packets in rate: Total number of data packets received within the specified time-window.
Bytes in rate: Total number of bytes received within the specified time-window.
Packets out rate: Total number of data packets transmitted within the specified time-window.
Bytes out rate: Total number of bytes transmitted within the specified time-window.
Packet inter-arrival times: Average, minimum, maximum, variance, and/or distribution of the duration between packet arrivals within the flow sample.
DPS: Mean, minimum, maximum, variance, and/or distribution of download packet size.
UPS: Mean, minimum, maximum, variance, and/or distribution of upload packet size.
DPR: Mean, minimum, maximum, variance, and/or distribution of download packet rate.
UPR: Mean, minimum, maximum, variance, and/or distribution of upload packet rate.
RR: Ratio between the mean, minimum, maximum, variance, and/or distribution of the rate of download to upload packets.
RS: Ratio between the mean, minimum, maximum, variance, and/or distribution of the in bytes rate to out bytes rate.
Flow sample data throughput: Total, mean, minimum, maximum, and/or variance of data flow sample per session.

In some embodiments, additional features may be calculated, based on the telemetry data associated with the connection context or connection multiplexity of the one or more instances of application or service usage sessions. In a non-limiting example, these features may include the following:
A number of active sub-connections associated with a particular application or service usage instance.
A number of opened and closed sub-connections per specified time period (e.g., between 1-240 seconds).
An order of opening of different connection types. Connection type may be determined based on a trained classifier which classifies connections into two or more classes, based, e.g., of a clustering or similar algorithm.
Mean, average, maximum, minimum, standard deviation, and distribution of connection open durations, and total upload and download data volumes passing therethrough.

In some embodiments, step 306 may comprise a noise reduction or removal stage, in which outlying features may be removed from the calculated feature set. Accordingly, in some embodiments, within each calculated feature category, each feature is compared to a category average, calculated based on all features obtained in the category. For example, as noted above, in step 304, a predetermined number of telemetry data samples, e.g., between 10-100 samples, may be gathered with respect to the uniquely-identified Internet host connection of interest. In step 306, a set of features may be calculated with respect to the uniquely-identified host connection, based on all the gathered samples. Then for each feature category (such as “data spikiness”), each calculated feature value may be compared to an average of all calculated feature values for this category within the gathered samples. In some embodiments, any feature that differs from the feature average value by a predetermined threshold (for example, by more than one standard deviation, or a similar threshold), may be removed from the feature set.

At the conclusion of step 306, the instructions of data traffic analysis module 206a may cause system 200 to obtain and store a set of telemetry-related features for the uniquely-identified host connection of interest, wherein the set of features represents telemetry data obtained from a predetermined minimum number of telemetry data samples, e.g., between 10-100 samples, gathered over a plurality of communications network, and representing a large variety of usage patterns and events, end users, network environments, days of the week, times of day, etc.

In some embodiments, in step 308, the instructions of machine learning classifier 206c may cause system 200 to inference a trained machine learning classifier 206c on the set of features extracted in step 306. In some embodiments, the trained machine learning classifier is configured to classify a set of telemetry-related features as associated with a particular application or Internet service category. Thus, inferencing the trained machine learning classifier obtains a classification of the set of telemetry-related feature calculated in step 306, as associated with a particular application/service category.

In some embodiments, in step 310, the instructions of machine learning classifier 206c may cause system 200 to determine an association between the uniquely-identified Internet host connection of interest and a particular application/service category, based on the inferencing performed in step 308.

In some embodiments, the instructions of machine learning classifier 206c may cause system 200 to store the learned association in central server/repository 132.

In some embodiments, in step 312, central server/repository 132 may be accessed, for example, by an ISP, a deployed access point (such as AP 108 within LAN 116, shown in FIG. 1A), or another service provider, to identify an actual application or service type being used by client-devices within serviced networks, and to use this information to improve overall service efficiency, allocate network resources more efficiently, and resolve network malfunctions.

The instructions of system 200 will now be discussed with reference to the flowchart of FIG. 3B, which illustrates the functional steps in a method 320 for consensus-based application-level classification of network traffic over a plurality of communications networks, in accordance with various aspects of the present disclosure.

The various steps of method 320 will be described with continued reference to the exemplary environments of FIGS. 1A-1B, and to system 200 shown in FIG. 2. The various steps of method 320 may either be performed in the order they are presented or in a different order (or even in parallel), as long as the order allows for a necessary input to a certain step to be obtained from an output of an earlier step. In addition, the steps of method 320 may be performed automatically (e.g., by system 200 of FIG. 2), unless specifically stated otherwise.

Method 320 begins in step 322, wherein a plurality of software agents, such as software agents 134 depicted in FIG. 1B, are deployed within a corresponding plurality of communications network, such as LAN 116 depicted in FIG. 1A. In some embodiments, each software agent 134 may be hosted within a network node in its respective network, e.g., an access point or router, such as AP 108 in the case of LAN 116. In some embodiments, each of software agents 134 is operationally and communicatively connected to, and controlled by, a central server, such as central server/repository 132. For example, central server/repository 132 may realize the components of system 200 centrally, to control and operate each of the software agents 134. Alternatively, system 200 may be realized by a distributed system, such that central server/repository 132 and each of software agents 134 may host a local instance of system 200 in its entirety, or at least some of the components of system 200, and operate by transmitting data from one system to the other (over a LAN, a WAN, the Internet, etc.).

In some embodiments, in step 324, the instructions of network traffic monitor 208 may cause system 200 to operate the various deployed software agents 134 to monitor and capture data traffic flows and telemetry data over their respective communications networks. In some embodiments, the data traffic flows are associated with instances of an application or service usage by an STA within the network in conjunction with a uniquely-identified Internet host connection of interest, e.g., one of Internet services platform 120-123 in FIG. 1A.

As used herein, “uniquely-identified” refers to the ability to detect and store a unique signature for an Internet host connection, wherein the unique signature comprises one or more connection-related attributes. The unique signature can then be used to positively or affirmatively identify the particular Internet host connection as associated with a new instance of data traffic connection. However, the unique signature does not necessarily indicate the type or category of application or service provided by the host, but rather only that this host is associated with a unique signature. The connection-related attributes which may be used to create a unique signature typically include Internet Protocol address (IP address), port number or a range of port numbers, domain name, and the like.

In some embodiments, the application/service category is one of the following: media streaming (including audio and video streaming), file downloading, file uploading, online gaming, conferencing, social network usage, Internet browsing, VPN session, electronic mail usage, and remote desktop sessions.

In some embodiments, the instructions of network traffic monitor 208 may cause system 200 to operate the various deployed software agents 134 to collect at least a predetermined number of telemetry data samples (e.g., between 10-100 samples) from each of the software agents 134, with respect to the uniquely-identified Internet host connection of interest.

In some embodiments, each telemetry data sample may represent an entire application/service category usage session by a user within a network, with respect to the uniquely-identified Internet host connection. For example, such a usage session may include all data traffic flow associated with an instance of usage (such as content streaming, a video conferencing call, or a gaming session) wherein a user accessed the uniquely-identified Internet host connection. In some embodiments, each usage session may have minimum length of between 1-30 minutes.

For example, with reference to FIG. 1A, an STA 102 within LAN 116 may initiate a data traffic session with an unknown application or Internet host, e.g., Internet host 121, to stream media over an Internet connection. In some embodiments, in order to fetch the service, the STA 102 may open one or more sub-connections, e.g., two or more parallel sub-connections to fetch the multiple resources comprising the requested service. In some embodiments, the respective software agent 134 may continuously or periodically monitor and sample the one or more established sub-connections, e.g., 1, 2, 3, 4, 5 or more sub-connections (which may be referred to as the ‘connection context’), to capture telemetry data associated with the service being provided to STA 102.

In some embodiments, the Internet host connection may be uniquely-identified by one, or a combination of two or more, connection attributes, including, but not limited to, Internet Protocol address (IP address), port number or a range of port numbers, domain name, and the like. Additionally or alternatively, the Internet host connection may be uniquely-identified by a specific combination of data flow-based, packet-based, or temporal-based (i.e., time-related) features extracted from data traffic flows associated with the Internet host connection.

In some embodiments, each software agent 134 may thus be operated to capture data packets associated with data traffic flows, and may further aggregate data packets into sequences or flows comprising IP data packets passing a monitoring point in the network during a certain time interval, such that all packets belonging to a particular flow sample have a set of common properties. In some embodiments, such time interval may be, e.g., 1, 5, 10, 15, 20, 25, 30, 60, 120 seconds or greater. Similarly, each software agent 134 may further be operated to analyze packet headers, to capture telemetry data about the traffic flows.

In some embodiments, each software agent 134 may be operated to capture connection attributes associated with each data flow between an STA and a host connection, such as, but not limited to:
Internet Protocol (IP) address.
Server IP
Uniform Resource Locater (URL).
Uniform Resource Identifier (URI).
Unique IDentifier (UID).
Media Access Control (MAC) address.
Service name.
Domain name.
Port numbers and ranges.
and/or
Protocol used.

Further example attributes in the captured telemetry data may include, but are not limited to, Transport Layer Security (TLS) information (e.g., from a TLS handshake), such as the ciphersuite offered, User Agent information, destination hostname, TLS extensions, etc., HTTP information (e.g., URI, etc.), Domain Name System (DNS) information, ApplicationID, virtual LAN (VLAN) ID, or any other data features that can be extracted from the observed traffic flows. Further information, if available, could also include process hash information from the process on the particular one or more STAs 102-106 that participates in the traffic flows. In addition, any number of statistics or metrics may be extracted regarding the traffic flows. For example, the start time, end time, duration, packet size(s), the distribution of bytes within a flow, etc., associated with the traffic flows.

In further embodiments, each software agent 134 may also be operated to assess the payload of the included packets in the traffic flows, to capture information about the traffic flows. For example, each software agent 134 may perform deep packet inspection (DPI) on one or more of the included packets, to assess the contents of the packets. Doing so may, for example, yield additional information that can be used to determine the application associated with the traffic flows (e.g., the packets were sent by a web browser of a particular one of STAs 102-106, by a videoconferencing application, etc.).

In some embodiments, the telemetry data may be captured over specified usage periods. For example, each software agent 134 may be operated to capture network traffic flows and telemetry data over a specified period of time, such as a period extending between 1 hour and 365 days of usage, e.g., 24 hours of usage. In some embodiments, a specified period of usage time may be a continuous period of usage, e.g., a continuous 24 hours representing usage of the device throughout all hours of the day.

In some embodiments, telemetry data may be captured over entire data traffic sessions between an STA and an Internet host, e.g., over entire usage sessions wherein a user may initiate a data traffic session with an application or Internet service, e.g., to stream media, to conduct a teleconference, etc.

In some embodiments, the instructions of network traffic monitor 208 may cause system 200 to operate each of software agents 134 to capture telemetry data associated with the connection context of one or more instances of application or service usage sessions. For example, in some embodiments, in order to fetch a particular service or application usage session, an STA, such as one of STAs 102-106, may open two or more sub-connections, e.g., 1, 2, 3, 4, 5 or more sub-connections, to fetch the multiple resources comprising the requested service. In some embodiments, the software agents 134 may be operated to continuously or periodically monitor and sample the established sub-connections, to capture telemetry data associated therewith.

In some embodiments, each software agent 134 may be operated to generate a record of each flow sample, which may include information about each flow sample that was observed, e.g., an application or service or Internet services associated with the flow sample, characteristic properties of a flow sample (e.g., IP addresses and port numbers) as well as size-based and temporal properties (e.g., packet and byte counters). In some embodiments, each software agent 134 may be operated to timestamp received flow samples upon packet arrival.

In some embodiments, each software agent 134 may be operated to determine an application or content or Internet service information associated with each flow sample, based on connection parameters such as, but not limited to, domain name, IP address, and/or port numbers. In some embodiments, a domain name may be determined using a Secure Socket Layer (SSL) certificate, which provides a fully qualified domain name associated with a server as verified by a trusted third party service. For example, a reverse DNS lookup or reverse DNS resolution (rDNS) may be carried out to determine the domain name associated with an IP address. In other examples, each software agent 134 may be operated to determine port numbers associated the IP address, and/or a transport protocol, e.g., Transmission Control Protocol (TCP) and the User Datagram Protocol (UDP). In the case of port number ranges, because many Internet resources use a known port or port ranges on their local host as a connection point to which other hosts may initiate communication, each software agent 134 may be operated to analyze TCP SYN packets to know the server side of a new client-server TCP connection.

In some embodiments, application and/or Internet service detection based on detecting a URL or a server IP address and associating the URL or IP address with a known domain found, e.g., in repository of domain names associated with a specified application or Internet service. For example, known domain names associated with any particular application or category of service may be identified and added to a database of domain name maintained by central server/repository 132. In some embodiments, such detection may be further supported by, e.g., an expression or a string (e.g., a regex) which may be associated with a particular application or Internet service (e.g., ‘Netflix’), an expected port range associated with the service type, or an expected protocol associated with the Internet service.

In some embodiments, a database of known domain names associated with particular applications or Internet services may be obtained using, e.g., a dedicated crawler configured to systematically browses the Internet for the purpose of identifying and indexing domain names based on a type, content, etc. A crawler typically travels over the Internet and accesses resources. The crawler inspects, e.g., the content or other attributes of resources. The crawler then follows hyperlinks to other resources. The results of the crawling are then extracted into a repository, which may be queried to find content that is relevant to a particular task. Thus, for example, a URL or IP address associated with a service being provided to an STA in LAN 116 may be matched with an entry in a domain repository maintained by system 200. In such case, the service may be determined to be a category of service associated with the matched domain name.

With reference back to FIG. 3B, in some embodiments, the instructions of network traffic monitor 208 may further cause system 200 to operate each of the software agents 134 to sample and/or filter the collected telemetry data, such that only certain packets are retained and forwarded for further processing. In some embodiments, a combination of several sampling and filtering steps can be adopted to select only packets of interest, to reduce computational load of subsequent stages or processes as well as the consumption of bandwidth and memory. For example, systematic sampling may be applied, wherein only every Nth packet is selected in a periodic sampling scheme. In other example, random sampling may be applied to select packets in accordance with a random process. In some embodiments, one or more filtering schemes may be applied, e.g., to select packets where specific fields within the packet (and/or the router state) are equal to a specified value or inside a specified value range. In other examples, packets that are used for handshake generation and do not contain any useful information about the protocol or service being used may be removed (e.g., SYN, ACK, FIN packets).

In some embodiments, in step 326, the instructions of data traffic analysis module 206a may cause system 200 to operate each of the software agents 134, to extract a set of features from the telemetry data captured and preprocessed in step 324.

In some embodiments, the extracted features may include, but are not limited to, data flow level or temporal (i.e., time-related) features, as well as packet-level or size-based features. In some embodiments, the features may be extracted from each telemetry sample with respect to a moving time-window interval of between 1-240 seconds, e.g., 30 seconds. In some embodiments, each of these features may be associated with one of the following categories of features:
Data spikiness: The ratio of time-windows within a flow sample showing data rates or packet rates which exceed one or more specific thresholds. In some embodiments, the one or more thresholds may reflect static values, e.g., 1 KB, 2 KB, 3 KB, 100 KB, 200 KB, 300 KB, or 10 packets, 30 packets, 50 packets, etc. In some embodiments, the threshold may be a dynamic threshold whose value may reflect, e.g., the average data/packet rate within a particular time-window or a series of two or more time-windows, plus the standard deviation of the data/packet rate.
Data spikes attributes: Statistics and metrics calculated with respect to identified data rate or packet rate spikes. Such statistics and metrics may be calculated with respect to the width, amplitude, and frequency of occurrence of data spikes, and may include, but are not limited to, mean values, average values, minimum values, maximum values, standard deviation, variance, and distribution.
Packet Rate: The number of packets in rate and packets out rate sent over one or more time-windows, including, but not limited to, mean values, average values, minimum values, maximum values, standard deviation, variance, and distribution.
Packet sizes: Mean values, average values, minimum values, maximum values, standard deviation, variance, and distribution of packet sizes transmitted over one or more time-windows.
Ratio of inbound-to-outbound data: The mean ratio between inbound and outbound data and/or packets over all time-windows in a flow sample, as well as minimum, maximum, variance, and/or distribution of such ratio.
Ratio of valid time-windows: The ratio of time-windows having a number of inbound packets that is greater than a specified threshold.
Inter-arrival timing of packets: A measure of time periods within a flow sample in which inbound (e.g., ‘quiet in’) or outbound data (e.g., ‘quiet out’) amounts to less than a specified threshold, e.g., 50B.

In some embodiments, each software agent 134 may be operated to calculate the following additional features, including, but not limited to:
Packets in rate: Total number of data packets received within the specified time-window.
Bytes in rate: Total number of bytes received within the specified time-window.
Packets out rate: Total number of data packets transmitted within the specified time-window.
Bytes out rate: Total number of bytes transmitted within the specified time-window.
Packet inter-arrival times: Average, minimum, maximum, variance, and/or distribution of the duration between packet arrivals within the flow sample.
DPS: Mean, minimum, maximum, variance, and/or distribution of download packet size.
UPS: Mean, minimum, maximum, variance, and/or distribution of upload packet size.
DPR: Mean, minimum, maximum, variance, and/or distribution of download packet rate.
UPR: Mean, minimum, maximum, variance, and/or distribution of upload packet rate.
RR: Ratio between the mean, minimum, maximum, variance, and/or distribution of the rate of download to upload packets.
RS: Ratio between the mean, minimum, maximum, variance, and/or distribution of the in bytes rate to out bytes rate.
Flow sample data throughput: Total, mean, minimum, maximum, and/or variance of data flow sample per session.

In some embodiments, each software agent 134 may be operated to calculate a set of features, based on the telemetry data associated with the connection context or connection multiplexity of the one or more instances of application or service usage sessions. In a non-limiting example, each software agent 134 may be operated to calculate at least the following features:
A number of active sub-connections associated with a particular application or service usage instance.
A number of opened and closed sub-connections per specified time period (e.g., between 1-240 seconds).
An order of opening of different connection types. Connection type may be determined based on a trained classifier which classifies connections into two or more classes, based, e.g., of a clustering or similar algorithm.
Mean, average, maximum, minimum, standard deviation, and distribution of connection open durations, and total upload and download data volumes passing therethrough.

In some embodiments, the present disclosure provides for a preprocessing stage within step 326, to preprocess the extracted parameters. In some embodiments, the preprocessing stage may comprise at least one of feature normalizing, feature selection, feature extraction, dimensionality reduction, and/or any other suitable preprocessing method or technique.

In some embodiments, step 326 may comprise a noise reduction or removal stage, in which outlying features may be removed from the calculated feature set. Accordingly, in some embodiments, within each calculated feature category, each feature is compared to a category average, calculated based on all features obtained in the category. For example, as noted above, in step 324, a predetermined number of telemetry data samples, e.g., between 10-100 samples, may be gathered with respect to the uniquely-identified Internet host connection of interest. In step 326, a set of features may be calculated with respect to the uniquely-identified host connection, based on all the gathered samples. Then for each feature category (such as “data spikiness”), each calculated feature value may be compared to an average of all calculated feature values for this category within the gathered samples. In some embodiments, any feature that differs from the feature average value by a predetermined threshold (for example, by more than one standard deviation, or a similar threshold), may be removed from the feature set.

In some embodiments, in step 328, the instructions of machine learning classifier 206c may cause system 200 to operate each of software agents 134 to inference a trained machine learning classifier 206c on the set of features extracted in step 326. In some embodiments, the trained machine learning classifier is configured to classify a set of features as associated with a particular application or Internet service category. Thus, inferencing the trained machine learning classifier obtains, in each case, a classification of the set of feature calculated in step 306, as associated with a particular application/service category.

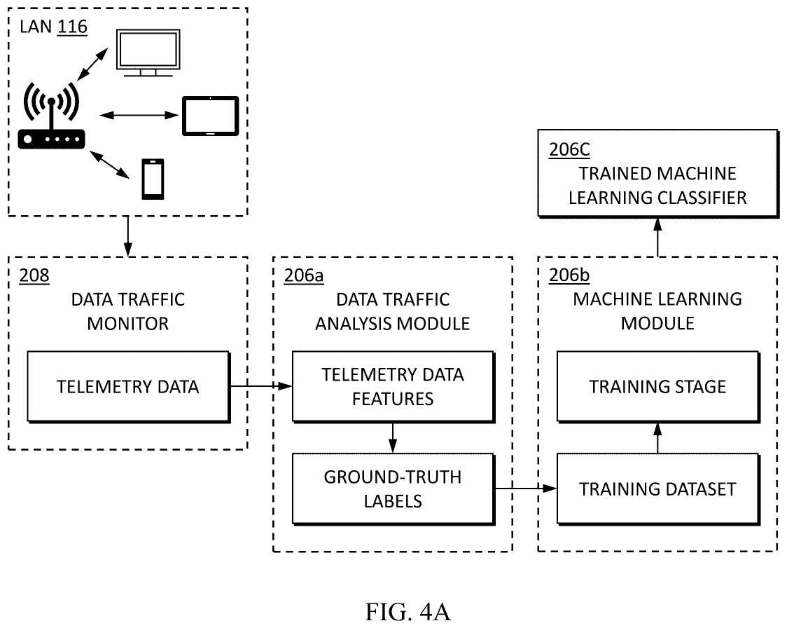

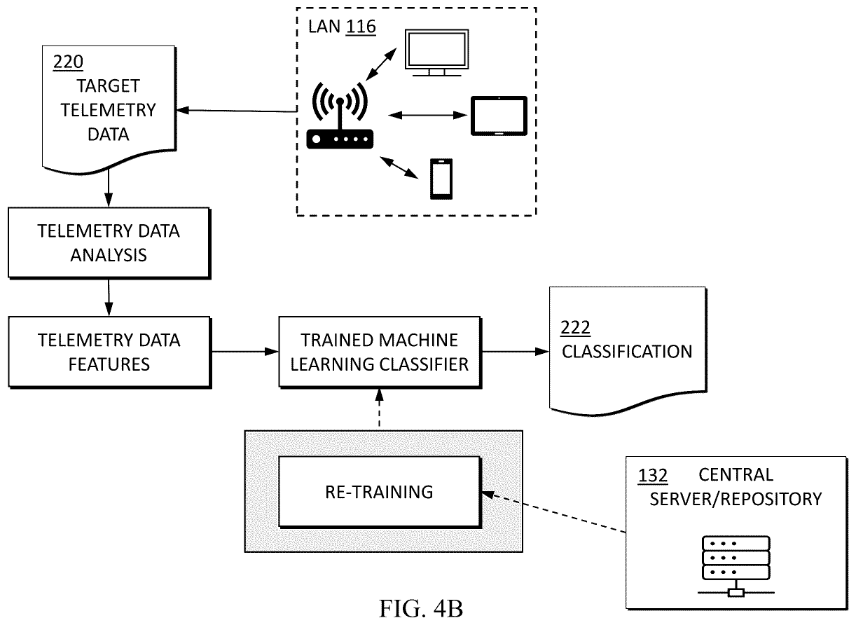

FIG. 4A depicts an exemplary pipeline for training a machine learning model of the present technique, as may be realized by machine learning classifier 206c of system 200, to classify input telemetry data as associated with a particular application/service category. The trained machine learning model may be used, e.g., in step 308 of method 300, wherein the instructions of machine learning classifier 206c may cause system 200 to inference the trained machine learning classifier 206c on the set of telemetry-related features, to classify the set of telemetry-related features as associated with a particular application or Internet service category.

The trained machine learning model may be trained on a training dataset comprising the set of telemetry-related feature, e.g., as calculated in steps 306 of method 300 and 326 of method 320, from the telemetry data collected and preprocessed in steps 304 and 324, respectively. Accordingly, the instructions of machine learning module 206b may cause system 200 to train a machine learning model on a training dataset comprising:
(i) The set of data traffic features extracted in step 306 of method 300 or step 326 of method 320; and
(ii) labels indicating an association between each of the features and a particular application/service category.

The obtained trained machine learning model is configured to be inferences over features extracted from input target telemetry data originating from an unknown application or Internet service, and to output an application-level classification of the target input telemetry data, which predicts the particular application or Internet service associated with input target telemetry data.

FIG. 4B illustrates an inferencing pipeline of a machine learning model of the present disclosure, as may be realized by machine learning classifier 206c of system 200, using a machine learning model trained as detailed above. A target data traffic flow captured in real-time is used to extract data traffic features that are fed into the machine learning classifier. The classifier's output indicates a specified Internet service associated with a target flow. Certain implementations may optionally allow the model to be updated in real-time, by continuously re-training the model using features and label obtained during real-time inference of the model.

In some embodiments, the instructions of machine learning classifier 206c may cause system 200 to operate each of software agents 134 to associate the classification results of step 328, in each case, with the uniquely-identified Internet host connection from which the underlying telemetry data originated. Accordingly, in step 328, each of the software agents 134 may learn an association connecting the uniquely-identified Internet host connection of interest with a particular application/service category.

In some embodiments, in step 330, the instructions of machine learning classifier 206c may cause system 200 to operate each of the software agents 134 to upload the various generated associations to central server/repository 132. In some embodiments, central server/repository 132 may store the learned associations, wherein the uniquely-identified Internet host connection of interest may be associated with a particular application or a type of Internet service.

Table 1 below shows an exemplary repository for storing the learned associations between each uniquely-identified Internet host connection (as uniquely-identified by an assigned signature) and a particular application or a type of Internet service.

TABLE 1

| | NUMBER OF FIELD | FINAL ASSOCIATED |
|---|---|---|
| SIGNATURE | CLASSIFICATIONS | APPLICATION/SERVICE |
| 912ec80 | 30 | Netflix (streaming) |
| 874df90 | 25 | Zoom (conferencing) |
| 546ty78 | 70 | Teams (conferencing) |
| 435gh86 | 43 | Amazon Prime (streaming) |
| 523uk75 | 55 | PlayStation Now (gaming) |

In some embodiments, in step 332, the instructions of system 200 may cause central server/repository 132 to apply a consensus-based process to resolve any potential conflicts among all of the learned associations uploaded by each of the software agents 134 in step 320.

As noted above, each of software agents 134 applies an instance of a trained machine learning model of the present technique to telemetry data obtained within the respective network monitored by a particular software agent 134. Thus, it may be the case that the uniquely-identified Internet host connection of interest may be classified by two separate software agents 134 in an inconsistent manner. For example, a first software agent 134, deployed over a first network, may classify data flows from a particular Internet host connection as associated with the service category of streaming. At the same time, a second software agent 134, deployed over a second network, may classify data flows from the same Internet host connection as associated with file downloading. The inconsistency may be the result of noise and variability in the data flows, even when using the same application or within the same service category. Thus, for example, central server/repository 132 may receive 25 ‘field’ classifications results from the various software agents 134 with respect to a particular Internet host connection. Of the 25 results, 21 may classify the Internet host connection as associated with a particular streaming application (e.g. YouTube), or more generally, with the service category of ‘streaming,’ while the remaining 4 results may classify the Internet host connection as associated with the service category of ‘file downloading.’ Accordingly, central server/repository 132 may determine that the Internet host connection is associated with the particular streaming application (e.g. YouTube), or with the service category of ‘streaming,’ as the case may be, based on the plurality or majority consensus among the received ‘field’ classification results. In some embodiments, the central repository may assign equal weights to all the received ‘field’ classifications, while in other cases, different weights may be assigned, e.g., based on the number of data flow samples used in reaching each particular classification results.

In some embodiments, central server/repository may then use the consensus classifications for periodic re-training and refining of the trained machine learning model of the present technique, as shown in FIG. 4B, to generate an updated version which may then be re-deployed as part of software agent 134 to the participating network nodes.

In some embodiments, In some embodiments, central server/repository 132 may be accessed, for example, by an ISP, a deployed access point (such as AP 108 within LAN 116, shown in FIG. 1A), or another service provider, to identify an actual application or service type being used by client-devices within serviced networks, and to use this information to improve overall service efficiency, allocate network resources more efficiently, and resolve network malfunctions.

In some embodiments, methods 300 and 320 may be performed in conjunction with one another, within the context of network environment 100 and 130 depicted in FIGS. 1A-1B. For example, the various steps of method 300 may be performed to generate a plurality of ‘field’ classifications with respect to one or more Internet host connection, wherein each of the classifications associate the Internet host connection with a particular application/service category, and represents data flow samples captured over a single network. Then, the various steps of method 320 may be performed the present generate a ‘central’ classification result representing with respect to the same Internet host connection, based on a relatively larger variety of data flow samples captured over multiple individual networks.

In some embodiments, system 200 may use the ‘central’ classification result obtained to validate ‘field’ classifications received from the various instances of the trained machine learning model deployed in the field. For example, central server/repository 132 may receive a number of ‘field’ classification results with respect to a particular Internet host connection. Central server/repository may use the ‘central’ classification to resolve any conflicts or disagreements among the various ‘field’ classifications, e.g., as part of the consensus mechanism described above. In some embodiments, the ‘central’ classification may be assigned a greater weight than the ‘field’ classifications, while in other cases, the ‘central’ classification may be assigned an equal weight.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a LAN, a WAN and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

1. A system comprising:
at least one hardware processor; and
a non-transitory computer-readable storage medium having stored thereon program instructions, the program instructions executable by the at least one hardware processor to:
capture, by each of a plurality of software agents monitoring a respective plurality of network interfaces, telemetry data representing a plurality of data flow samples associated with an unknown Internet host connection, wherein said unknown Internet host connection is assigned a unique identifier,
process, by each of said plurality of software agents, said telemetry data to calculate a respective feature set for said unknown Internet host connection,
apply, by each of said software agents, a respective instance of a trained machine learning classifier to said respective feature set calculated by said software agent, to obtain a respective field classification which associates said unknown Internet host connection with a particular application or Internet service category, and
determine a final classification with respect to said at unknown Internet host connection, which associates said unique identifier with a particular application or Internet service category, based on a majority or plurality consensus among all of said field classifications.

2. The system of claim 1, wherein said unique identifier is based, at least in part, on one or more connection-related attributes selected from the group consisting of: Internet Protocol (IP) address, server IP, Uniform Resource Locater (URL), Uniform Resource Identifier (URI), Unique IDentifier (UID), Media Access Control (MAC) address, service name, domain name, port numbers and ranges, and protocol used.

3. The system of claim 1, wherein said unique identifier is based, at least in part, on a combination of data flow-based features extracted from data traffic flows associated with the Internet host connection.

4. The system of claim 1, wherein said feature set calculated by each of said software agents comprises features representing at least one of the following feature categories:
(i) the ratio of time-windows within each of said data flow samples having data spikes representing data rates or packet rates which exceed a specified threshold;
(ii) statistics associated with the width, amplitude, and frequency of occurrence of said data spikes;
(iii) statistics associated with inbound and outbound data and packet rates over said time-windows;
(iv) statistics associated with packet sizes in said time-windows;
(v) the ratio of said time-windows having a number of inbound packets that is greater than a specified threshold; and
(vi) a measure of time periods within each of said time-windows in which inbound or outbound data rates are below a specified threshold.

5. The system of claim 1, wherein at least some of said data flow samples represent an entire usage session by a client-device with respect to said application or Internet service provided by said Internet host connection.

6. The system of claim 1, wherein, with respect to each of said software agents, said plurality of data flow samples comprises at least 10 data flow samples.

7. The system of claim 1, wherein all of said field classifications are uploaded to a central server, wherein said determining is performed by said central server, and wherein said final classifications are stored at said central server.

8. A computer-implemented method comprising:
capturing, by each of a plurality of software agents monitoring a respective plurality of network interfaces, telemetry data representing a plurality of data flow samples associated with an unknown Internet host connection, wherein said unknown Internet host connection is assigned a unique identifier;
processing, by each of said plurality of software agents, said telemetry data to calculate a respective feature set for said unknown Internet host connection;
applying, by each of said software agents, a respective instance of a trained machine learning classifier to said respective feature set calculated by said software agent, to obtain a respective field classification which associates said unknown Internet host connection with a particular application or Internet service category; and
determining a final classification with respect to said at unknown Internet host connection, which associates said unique identifier with a particular application or Internet service category, based on a majority or plurality consensus among all of said field classifications.

9. The computer-implemented method of claim 8, wherein said unique identifier is based, at least in part, on one or more connection-related attributes selected from the group consisting of: Internet Protocol (IP) address, server IP, Uniform Resource Locater (URL), Uniform Resource Identifier (URI), Unique IDentifier (UID), Media Access Control (MAC) address, service name, domain name, port numbers and ranges, and protocol used.

10. The computer-implemented method of claim 8, wherein said unique identifier is based, at least in part, on a combination of data flow-based features extracted from data traffic flows associated with the Internet host connection.

11. The computer-implemented method of claim 8, wherein said feature set calculated by each of said software agents comprises features representing at least one of the following feature categories:
(i) the ratio of time-windows within each of said data flow samples having data spikes representing data rates or packet rates which exceed a specified threshold;
(ii) statistics associated with the width, amplitude, and frequency of occurrence of said data spikes;
(iii) statistics associated with inbound and outbound data and packet rates over said time-windows;
(iv) statistics associated with packet sizes in said time-windows;
(v) the ratio of said time-windows having a number of inbound packets that is greater than a specified threshold; and
(vi) a measure of time periods within each of said time-windows in which inbound or outbound data rates are below a specified threshold.

12. The computer-implemented method of claim 8, wherein at least some of said data flow samples represent an entire usage session by a client-device with respect to said application or Internet service provided by said Internet host connection.

13. The computer-implemented method of claim 8, wherein, with respect to each of said software agents, said plurality of data flow samples comprises at least 10 data flow samples.

14. The computer-implemented method of claim 8, wherein all of said field classifications are uploaded to a central server, wherein said determining is performed by said central server, and wherein said final classifications are stored at said central server.

15. A computer program product comprising a non-transitory computer-readable storage medium having program instructions embodied therewith, the program instructions executable by at least one hardware processor to:
capture, by each of a plurality of software agents monitoring a respective plurality of network interfaces, telemetry data representing a plurality of data flow samples associated with an unknown Internet host connection, wherein said unknown Internet host connection is assigned a unique identifier;
process, by each of said plurality of software agents, said telemetry data to calculate a respective feature set for said unknown Internet host connection;
apply, by each of said software agents, a respective instance of a trained machine learning classifier to said respective feature set calculated by said software agent, to obtain a respective field classification which associates said unknown Internet host connection with a particular application or Internet service category; and
determine a final classification with respect to said at unknown Internet host connection, which associates said unique identifier with a particular application or Internet service category, based on a majority or plurality consensus among all of said field classifications.

16. The computer program product of claim 15, wherein said unique identifier is based, at least in part, on one or more connection-related attributes selected from the group consisting of: Internet Protocol (IP) address, server IP, Uniform Resource Locater (URL), Uniform Resource Identifier (URI), Unique IDentifier (UID), Media Access Control (MAC) address, service name, domain name, port numbers and ranges, and protocol used.

17. The computer program product of claim 15, wherein said unique identifier is based, at least in part, on a combination of data flow-based features extracted from data traffic flows associated with the Internet host connection.

18. The computer program product of claim 15, wherein said feature set calculated by each of said software agents comprises features representing at least one of the following feature categories:
(i) the ratio of time-windows within each of said data flow samples having data spikes representing data rates or packet rates which exceed a specified threshold;
(ii) statistics associated with the width, amplitude, and frequency of occurrence of said data spikes;
(iii) statistics associated with inbound and outbound data and packet rates over said time-windows;
(iv) statistics associated with packet sizes in said time-windows;
(v) the ratio of said time-windows having a number of inbound packets that is greater than a specified threshold; and
(vi) a measure of time periods within each of said time-windows in which inbound or outbound data rates are below a specified threshold.

19. The computer program product of claim 15, wherein at least some of said data flow samples represent an entire usage session by a client-device with respect to said application or Internet service provided by said Internet host connection.

20. The computer program product of claim 15, wherein, with respect to each of said software agents, said plurality of data flow samples comprises at least 10 data flow samples.
